(19) United States
(12) Patent Application Publication
(10) Pub. No.: US 2020/0174402 A1
(43) Pub. Date: Jun. 4, 2020

(54) CLEANING DEVICE AND IMAGE FORMING APPARATUS

(71) Applicant: Konica Minolta Inc., Tokyo (JP)

(72) Inventor: TAICHI MEGURO, Tokyo (JP)

(21) Appl. No.: 16/694,765

(22) Filed: Nov. 25, 2019

(30) Foreign Application Priority Data
Nov. 30, 2018 (JP) 2018-225078

(51) Int. Cl. G03G 15/16; G03G 21/00

(52) U.S. Cl. CPC G03G 15/161; G03G 21/0011; G03G 2221/0047; G03G 2221/0005; G03G 15/1665

(57) ABSTRACT

A cleaning device includes a cleaning blade that contacts an image carrier and cleans the image carrier; an application roller that contacts the image carrier on an upstream side of the cleaning blade in a conveyance direction of the image carrier and applies toner to the image carrier, a plate member that contacts the application roller and applies the toner to the application roller, and a discharge mechanism that performs a toner discharge operation for discharging the toner stored in a space formed above a contact part between the plate member and the application roller.

The entire disclosure of Japanese patent Application No. 2018-225078, filed on Nov. 30, 2018, is incorporated herein by reference in its entirety.

### BACKGROUND

### Technological Field

The present invention relates to a cleaning device and an image forming apparatus.

### Description of the Related Art

In an electrophotographic image forming apparatus, a technique has been known for cleaning an image carrier such as an intermediate transfer belt or a photosensitive drum by a cleaning blade (hereinafter also simply referred to as “blade”). Specifically, an external additive separated from toner is dammed at the contact part between the image carrier and the blade to form a stationary layer of the external additive, and the toner is dammed by the stationary layer. Thus, the image carrier is cleaned.

Such a stationary layer also has a function of preventing the blade from being dragged by the image carrier. Specifically, since the external additive forming the stationary layer slightly slips through the contact part between the image carrier and the blade, the contact area between the image carrier and the blade is reduced. Therefore, a frictional force between the image carrier and the blade is also reduced, so that the blade is prevented from being dragged.

However, when an image of a low coverage or an image unevenly positioned in a direction perpendicular to the conveyance direction of the image carrier (for example, the axial direction of the photosensitive drum) is continuously printed, an amount of toner reaching the blade and an amount of external additive contained in the toner are decreased, and therefore, the stationary layer is depleted. When the stationary layer is depleted, the blade is excessively dragged by the image carrier, and therefore, cut-surface wear (wear of a chamfered portion from an edge toward a cut surface (toward an upstream side in a rubbing direction)) of the blade may occur. If printing is continued in a state where the cut-surface wear has occurred, the edge of the blade may be worn starting from the cut-surface wear, which may lead to a cleaning failure. That is, in order to prevent an occurrence of a cleaning failure, it is necessary to stably supply toner to the blade to prevent the cut-surface wear of the blade.

In relation to the above, JP 2005-275219 A discloses a cleaning means (cleaning device) that stores toner by a plurality of members arranged on the upstream side of a blade and supplies the toner to the blade, for example. In this cleaning means, the amount of stored toner is detected, and when the detected amount of toner is small, additional toner is supplied to the blade to prevent damage on the blade.

However, the cleaning means disclosed in JP 2005-275219 A detects the amount of stored toner but does not detect the state of the toner. Therefore, even if the stored toner has been continuously rubbed by a roller-shaped member or the like for a long period of time and thus has deteriorated with the external additive being embedded, such a state of toner is not detected. Therefore, the deteriorated toner with the external additive being embedded may be supplied to the blade, and thus, there is a problem that a stationary layer of the external additive is not formed, and a cleaning failure due to cut-surface wear may occur. In particular, in a hot and wet environment, the frictional force between the image carrier and the blade increases, so that a cleaning failure due to the cut-surface wear may significantly occur.

### SUMMARY

The present invention has been made in view of the above-described problems. Accordingly, an object of the present invention is to provide a cleaning device and an image forming apparatus that prevent an occurrence of a cleaning failure due to cut-surface wear of a cleaning blade which is caused depending on the state of supplied toner.

To achieve the abovementioned object, according to an aspect of the present invention, a cleaning device reflecting one aspect of the present invention comprises a cleaning blade that contacts an image carrier and cleans the image carrier, an application roller that contacts the image carrier on an upstream side of the cleaning blade in a conveyance direction of the image carrier and applies toner to the image carrier, a plate member that contacts the application roller and applies the toner to the application roller, and a discharge mechanism that performs a toner discharge operation for discharging the toner stored in a space formed above a contact part between the plate member and the application roller.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a view illustrating a schematic configuration of an image forming apparatus according to an embodiment of the present invention;

FIG. 2 is a view illustrating a schematic configuration of an image forming unit;

FIG. 3 is a view illustrating a schematic configuration of a cleaning device;

FIG. 4 is a diagram illustrating an example of an evaluation result of cut-surface wear when a contact force and a pressing force vary;

FIGS. 5A and 5B are diagrams for describing a contact method of a plate member;

FIGS. 6A to 6D are diagrams illustrating an example of an operation of storing toner and discharging toner;

FIG. 7 is a flowchart illustrating a procedure of a process of the image forming apparatus;

FIGS. 8A and 8B are diagrams for describing a method for calculating coverage gait image; and

FIG. 9 is a diagram illustrating an example of a table for setting a predetermined distance.

### DETAILED DESCRIPTION OF EMBODIMENTS

Hereinafter, one or more embodiments of the present invention will be described with reference to the drawings. However, the scope of the invention is not limited to the disclosed embodiments. In the description of the drawings, the same elements are denoted by the same reference numerals, and redundant description is omitted. In addition, the dimensional ratios in the drawings are exaggerated for convenience of description, and may differ from actual ratios.

(Configuration)

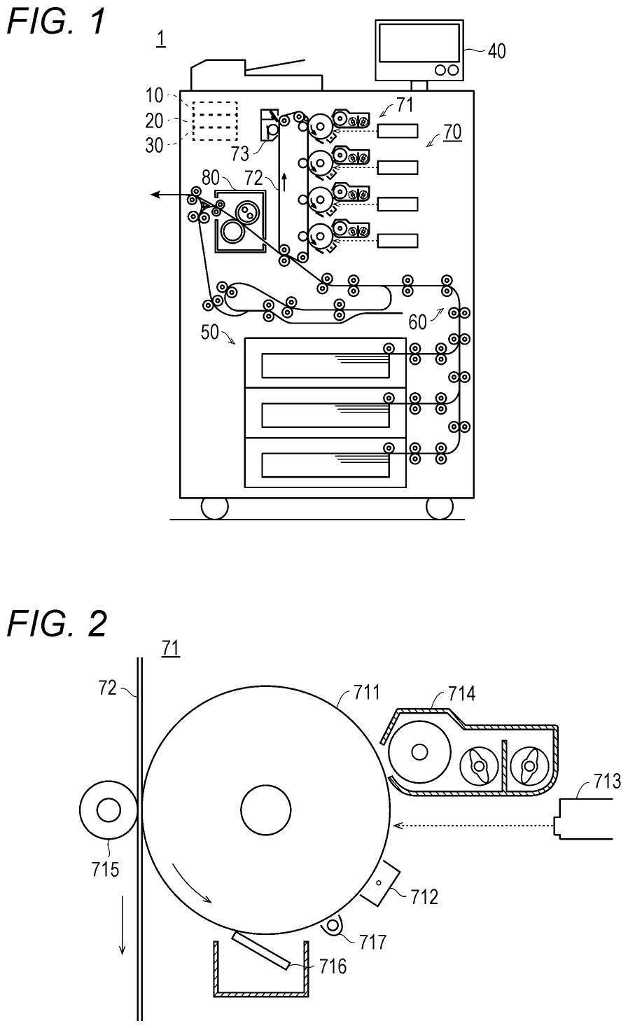

FIG. 1 is a view illustrating a schematic configuration of an image forming apparatus according to an embodiment of the present invention. FIG. 2 is a view illustrating, a schematic configuration of an image forming nit.

As illustrated in FIG. 1, the image forming apparatus 1 includes a controller 10, a storage 20, a communicator 30, an operation panel 40, a sheet feeder 50, a conveyor 60, an image former 70, and a fixing unit 80. The respective components are connected to each other via a bus for exchanging signals.

The controller 10 includes a central processing unit (CPU), and executes control of the respective components described above and various kinds of computing processes according to a program.

The storage 20 includes a read only memory (ROM) that stores various kinds of programs and various kinds of data in advance, a random access memory (RAM) that temporarily stores programs and data as a work area, a hard disk that stores various kinds of programs and various kinds of data, and the like.

The communicator 30 includes an interface for communicating with other devices such as a user's personal computer (PC) via a network such as a local area network (LAN). For example, the communicator 30 receives a print job from a user's PC.

The operation panel 40 includes, for example, a touch panel, a numeric keypad, a start button, and a stop button, and displays various types of information and receives various types of operations.

The sheet feeder 50 includes a sheet feed tray that stores sheet used for printing, and feeds the sheet stored in the sheet feed tray one by one.

The conveyor 60 includes a conveyance path, a plurality of conveyance roller pairs arranged along the conveyance path, and a drive motor (not shown) for driving the conveyance roller pairs, and conveys the sheet fed by the sheet feeder 50 along the conveyance path.

The image former 70 includes an image forming unit 71 for each color such as yellow (Y), magenta (M), cyan (C), and black (K), an intermediate transfer belt 72, and a cleaning device 73 for cleaning the intermediate transfer belt 72.

The image forming unit 71 forms an image with toner of each color. As illustrated in FIG. 2, the image forming unit 71 includes a photosensitive drum 711 as an image carrier, and includes, around the photosensitive drum 711, a charger 712, an exposure device 713, a developing device 714, a transfer roller 715, a cleaning device 716, and an eraser 717. The charger 712 uniformly charges the surface of the photosensitive drum 711 to a constant potential. The exposure device 713 exposes the surface of the photosensitive drum 711 charged by the charger 712 to form an electrostatic latent image corresponding to image data. The developing device 714 develops the electrostatic latent image formed by the exposure device 713 into a toner image. The transfer roller 715 transfers the toner image formed by the developing device 714 and conveyed by the photosensitive drum 711 to the intermediate transfer belt 72. The cleaning device 716 cleans the photosensitive drum 711 by damming toner and the like on the photosensitive drum 711 with a cleaning blade or the like. The eraser 717 eliminates static electricity from the surface of the photosensitive drum 711.

The developing device 714 for each color includes a two-component developer composed of toner of each color of yellow, magenta, cyan, and black having a small particle diameter, and a carrier. The two-component developer consists of a carrier including a ferrite as a core and an insulating resin coating the core, and toner containing polyester as a main component and additionally containing a colorant such as pigment or carbon black, a charge control agent, and an external additive such as silica or titanium oxide.

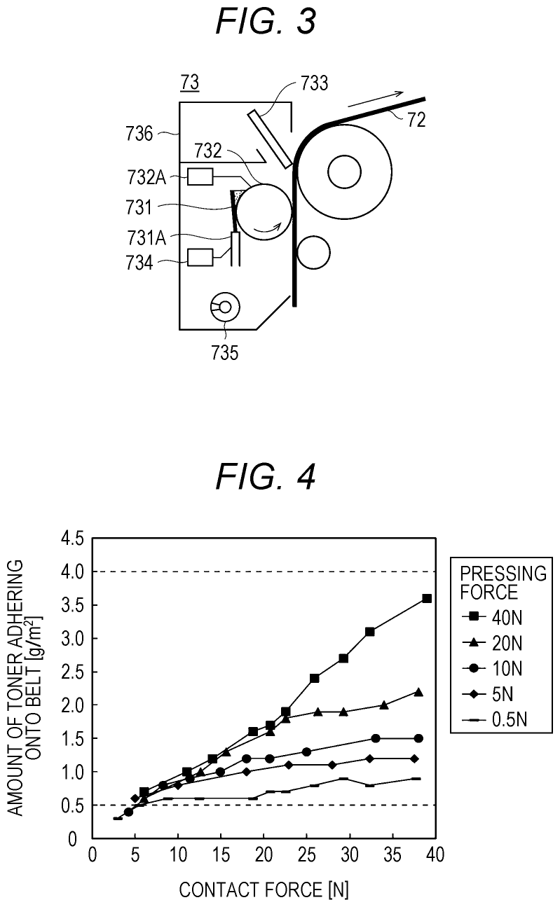

As illustrated in FIG. 1, the intermediate transfer belt 72 as an image carrier is an endless belt supported by a plurality of rollers so as to be able to run. The intermediate transfer belt 72 conveys the toner image transferred by the image forming unit 71 in a primary transfer area to a secondary transfer area, and transfers the conveyed toner image to a sheet in the secondary transfer area. As described above, the intermediate transfer belt 72 includes the cleaning device 73 that cleans the intermediate transfer belt 72. Details of the cleaning device 73 will be described later with reference to FIG. 3.

The fixing unit 80 includes a heating roller and a pressure roller, and heats and presses the sheet on which the image is formed by the image former 70, thereby fixing the image on the sheet.

Note that the image forming apparatus 1 may include components other than the above-described components, or may not include some of the above-described components.

Next, the details of the cleaning device 73 will be described.

FIG. 3 is a view illustrating a schematic configuration of the cleaning device.

As illustrated in FIG. 3, the cleaning device 73 includes a plate member 731, an application roller 732, a blade (cleaning blade) 733, a discharge mechanism 734, a collecting screw 735, and a housing 736 for housing these components.

(Plate Member)

The plate member 731 is a plate-like member that contacts the application roller 732 and applies toner to the application roller 732. The plate member 731 is disposed so as to be in contact with the application roller 732 with a predetermined contact force. As illustrated in FIG. 3, it is preferable that one end (upper end) of the plate member 731 is a free end, and the other end (lower end) is a fixed end fixed to a holding member 731A. Note that the holding member 731A may be attached to the housing 736 via an arbitrary member.

The plate member 731 is preferably a metal leaf spring material. This is to prevent creep deformation of the plate member 731 that may occur when the plate member 731 is made of, for example, polyethylene terephthalate (PET) or a non-leaf-spring material, and ensure performance of the plate member 731 for applying toner to the application roller 732. Examples of the material of the plate member 731 include, but are not limited to, stainless steel strips for springs such as SUS301-CSP, SUS304-CSP, or SUS631-CSP. In addition, the plate member 731 preferably has a thickness of 50 μm or more and less than 200 μm in order to ensure a contact force and followability to the application roller 732 and form a predetermined nip with the application roller 732.

(Application Roller)

The application roller 732 is a roller-like member that rotates in contact with the intermediate transfer belt 72 and applies the toner applied by the plate member 731 to the intermediate transfer belt 72. The application roller 732 rotates at a predetermined speed in the width direction (the direction in which the surface moves in the same direction) with respect to the conveyance direction of the intermediate transfer belt 72 by being driven by a drive motor 732A. In one example, the application roller 732 rotates in the width direction with respect to the conveyance direction of the intermediate transfer belt 72 at a speed with a linear speed ratio of 0.45 relative to the intermediate transfer belt 72.

The application roller 732 is disposed so as to press the intermediate transfer belt 72 with a predetermined pressing force. Further, the application roller 732 is disposed to form a space (hatched portion illustrated in FIG. 3, hereinafter referred to as “storage space”) for storing toner above the contact part with the plate member 731 (in the direction opposite to the direction of gravity).

The application roller 732 preferably has an elastic layer in order to form a predetermined nip between the application roller 732 and each of the plate member 731 and the intermediate transfer belt 72. This is because, even when the application roller 732 is inclined in the axial direction or has a partial variation in the outer diameter, the elastic layer absorbs the inclination and the variation. The elastic layer is preferably composed of a foamed sponge in order to hold a sufficient amount of toner on the surface of the application roller 732.

In one embodiment, in the foamed sponge constituting the elastic layer, the diameter of a cell is preferably 100 μm or more and 350 μm or less, and an occupation rate of cells per unit area is preferably 30% or more and less than 70%. In the present embodiment, the occupation rate of cells per unit area means a value obtained by dividing the total area of cells existing in the unit area (1 mm×1 mm) on the surface of the application roller 732 by the unit area. In one example, when the cell diameter is set to 100 μm or more and 350 nm or less and the occupation rate of cells per unit area is set to 30% or more and less than 70%, toner in an amount necessary for preventing cut-surface wear of the blade 733 is retained in the foamed sponge.

On the other hand, when the cell diameter is set to less than 100 μm and the occupation rate of cells per unit area is set to 30% or less, toner in an amount necessary for preventing cut-surface wear of the blade 733 is not retained in the foamed sponge.

When the cell diameter is set to be greater than 350 urn, the foamed sponge becomes hollow in the thickness direction of the foamed sponge. Therefore, when the plate member 731 is brought into contact with the application roller 732 or the application roller 732 is pressed against the intermediate transfer belt 72, the foamed sponge may be chipped. When the foamed sponge is chipped, the outer diameter of the application roller 732 decreases, and the amount of engagement between each of the plate member 731 and the intermediate transfer belt 72 and the application roller 732 also decreases. For this reason, in the foamed sponge, toner in an amount necessary for preventing the cut-surface wear of the blade 733 is not retained.

When the occupation rate of cells per unit area is set to 80% or more, the contact area between each of the plate member 731 and the intermediate transfer belt 72 and the non-cell portion of the application roller 732 decreases. Therefore, the contact force of the plate member 731 against the application roller 732 and the pressing force of the application roller 732 against the intermediate transfer belt 72 may concentrate on the non-cell portion, and the cell skeleton may be broken. When the cell skeleton is broken, the volume of the foamed sponge decreases, so that toner in an amount necessary for preventing the cut-surface wear of the blade 733 is not retained in the foamed sponge.

(Blade)

The blade 733 is a flat plate member that contacts the intermediate transfer belt 72 and cleans the intermediate transfer belt 72. As illustrated in FIG. 3, the blade 733 contacts the intermediate transfer belt 72 in the counter direction with respect to the conveyance direction of the intermediate transfer belt 72 on the downstream side of the application roller 732 in the conveyance direction of the intermediate transfer belt 72. The toner applied to the intermediate transfer belt 72 by the application roller 732 is supplied to the blade 733 as the intermediate transfer belt 72 is conveyed. Then, the blade 733 dams the external additive separated from the toner at the contact part with the intermediate transfer belt 72, so that a stationary layer of the external additive is formed. The stationary layer dams the toner, and thus, the intermediate transfer belt 72 is cleaned.

The blade 733 may be made of, for example, urethane rubber in order to achieve desired cleaning performance for toner, the contact force of the blade 733 against the intermediate transfer belt 72 may be 15 to 40 N/m, and the contact angle may be 12 to 23°. However, the material of the blade 733, the contact condition with respect to the intermediate transfer belt 72, and the like are not limited to these examples, and may be set so that desired cleaning performance can be achieved.

(Discharge Mechanism)

The discharge mechanism 734 includes an actuator and the like, and performs a toner discharge operation for discharging toner stored in the storage space described above by controlling the position, angle, size, and the like of the plate member 731. More specifically, the discharge mechanism 734 performs the discharge operation for discharging toner which has been continuously rubbed in the storage space by the application roller 732 for a long period of time and thus has deteriorated with the external additive being embedded, for example. A situation in which the same toner is rubbed for a long period of time occurs, for example, when images of a low coverage are continuously printed. The toner discharge operation performed by the discharge mechanism 734 will be described in detail later.

(Collecting Screw)

The collecting screw 735 is a member that collects unnecessary toner and conveys the collected toner to the outside of the housing 736. The collecting screw 735 collects, for example, toner which overflows beyond the capacity of the storage space as described above and drops by its own weight, or toner discharged by the discharge operation performed by the discharge mechanism 734. The toner collected by the collecting screw 735 may be conveyed to a collecting container (not shown) disposed in an arbitrary space of the image forming apparatus 1.

Next, the relationship among the components in the cleaning device 73 will be described in more detail.

(Setting of Contact Force and Pressing Force)

The amount of toner applied to the application roller 732 by the plate member 731 is controlled by the contact force of the plate member 731 against the application roller 732 (hereinafter also simply referred to as “contact force”). Further, the amount of toner applied to the intermediate transfer belt 72 by the application roller 732 and supplied, to the blade 733 is controlled by the pressing force of the application roller 732 against the intermediate transfer belt 72 (hereinafter also simply referred to as “pressing force”).

In order to supply the blade 733 with an amount of toner necessary to prevent cut-surface wear, the contact force of the plate member 731 and the pressing force of the intermediate transfer belt 72 need to be set to a value within an appropriate range. In addition, when toner is excessively supplied to the blade 733, the blade 733 cannot completely remove the toner, and the toner exceeds the cleaning limit of the blade 733, resulting in that a cleaning failure occurs. For this reason, it is preferable that not only lower limit values but also upper limit values are set as thresholds of the contact force and the pressing force.

In one embodiment, the contact force of the plate member 731 against the application roller 732 is preferably set to 5 N or more and less than 40 N, and more preferably set to 15 N or more and 30 N or less. Further, the pressing force of the application roller 732 against the intermediate transfer belt 72 is preferably set to 0.5 N or more and less than 40 N, and more preferably set to 10 N or more and 20 N or less.

FIG. 4 is a diagram illustrating an example of an evaluation result of the cut-surface wear when the contact force and the pressing force vary.

In one example, when the contact force of the plate member 731 is set to 5 N or more and less than 40 N, an amount of toner adhering to the application roller 732 is controlled to be 5 g/m² or more and less than 50 g/m². Further, when the contact force of the plate member 731 is set to 5 N or more and less than 40 N and the pressing force of the application roller 732 is set to 0.5 N or more and less than 40 N, an amount of toner adhering to the intermediate transfer belt 72 is controlled to be 0.5 g/m² or more and less than 4 g/m² as illustrated in FIG. 4. The amount of toner adhering to the intermediate transfer belt 72 corresponds to the amount of toner supplied to the blade 733. As a result, toner in an amount necessary for preventing the cut-surface wear of the blade 733 is stably supplied to the blade 733.

Further, when the contact force of the plate member 731 is set to 1.5 N or more and 30 N or less and the pressing force of the application roller 732 is set to 10 N or more and 20 N or less, toner in an amount necessary for preventing the cut-surface wear of the blade 733 is supplied to the blade 733, even when there is an influence of disturbance such as a usage environment of the cleaning device.

If the contact force of the plate member 731 is set to less than 5 N, a sufficient amount of toner is not applied to the application roller 732 by the plate member 731. For this reason, the amount of toner adhering to the application roller 732 becomes less than 5 g/m², and as a result, a cleaning failure due to cm-surface wear of the blade 733 may occur. When the contact force of the plate member 731 is set to 40 N or more, an excessive amount of toner is applied, to the application roller 732 by the plate member 731. For this reason, the amount of toner adhering to the application roller 732 becomes 50 g/m² or more which is beyond the cleaning limit of the blade 733, and as a result, a cleaning failure may occur.

When the pressing force of the application roller 732 is set to less than 0.5 N, a sufficient amount of toner is not applied to the intermediate transfer belt 72 by the application roller 732. For this reason, the amount of toner adhering to the intermediate transfer belt 72 becomes less than 0.5 g/m², and a cleaning failure due to the cut-surface wear of the blade 733 occurs. When the pressing force of the application roller 732 is set to 40 N or more, an excessive amount of toner is applied to the intermediate transfer belt 72 by the application roller 732. For this reason, the amount of toner adhering to the intermediate transfer belt 72 becomes 4 g/m² or more which is beyond the cleaning limit of the blade 733, and as a result, a cleaning failure may occur.

(Non-Edge Contact)

As illustrated in FIG. 3, the plate member 731 is disposed so that a non-edge portion of the plate member 731 contacts the application roller 732 (also referred to as “belly contact” or “non-edge contact”). This configuration will be described in detail.

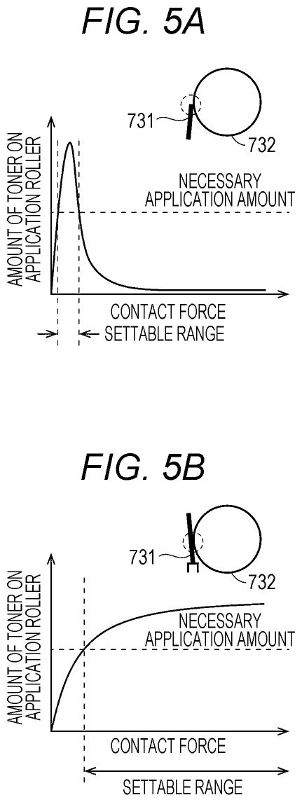

FIGS. 5A and 5B are diagrams for describing a contact method of the plate member.

FIG. 5A shows the relationship between the contact force of the plate member 731 and the amount of toner applied to the application roller 732 when the edge portion of the plate member 731 contacts the application roller 732 (edge contact). When the contact force in the edge contact is great, the plate member 731 which is to apply toner to the application roller 732 conversely scrapes the toner from the application roller 732, and therefore, a necessary amount of toner is not applied. For this reason, in the edge contact, a settable range of the contact force is narrow as illustrated in FIG. 5A. In addition, when the contact force in the edge contact is great, the edge portion of the plate member 731 may damage or deteriorate the surface of the application roller 732. Therefore, from the viewpoint of protecting the surface of the application roller 732, an upper limit value of the settable contact force is small.

Even when a contact force by which a necessary amount of toner can be applied is set, an error in the contact force may occur due to, for example, the use environment of the cleaning device 73 or dimensional variation of the components. As described above, in the edge contact, the settable range of the contact force is small. Therefore, if there is even the slightest error in the contact force, a necessary amount of toner may not be applied.

In view of this, the plate member 731 is disposed such that the non-edge portion thereof is in contact with the application roller 732. FIG. 5B illustrates the relationship between the contact force of the plate member 731 and the amount of toner applied to the application roller 732 in non-edge contact. In the non-edge contact, the plate member 731 does not scrape the toner from the application roller 732 regardless of the magnitude of the contact force, so that the settable range of the contact force is wide. Further, in the non-edge contact, there is no chance that the edge portion of the plate member 731 damages or deteriorates the surface of the application roller 732, and even if an error in the contact force occurs, a necessary amount of toiler can be applied.

(Operation of Storing and Discharging Toner)

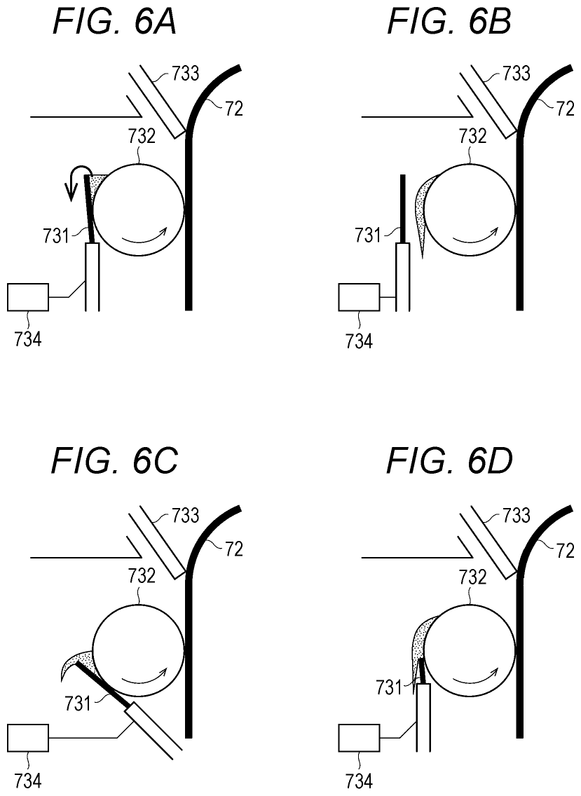

FIGS. 6A to 6D are diagrams illustrating an example of an operation of storing and discharging toner. More specifically, in FIGS. 6A to 6D, FIG. 6A is a view for describing an example of the operation of storing toner, and FIGS. 6B to 6D are views for describing various examples of the operation of discharging toner.

As shown in FIG. 6A, the plate member 731 and the application roller 732 form a storage space above the contact part, and toner (shown in gray in FIGS. 6A to 6D) is stored therein. During normal operation while printing, the plate member 731 applies the toner stored in the storage space at the contact part with the application roller 732. The toner beyond the capacity of the storage space overflows over the free end that is the upper end of the plate member 731 and is discharged in the direction indicated by an arrow.

On the other hand, in the present embodiment, the toner stored in the storage space can be discharged by a toner discharge operation performed by the discharge mechanism 734. For example, as shown in FIG. 6B, the discharge mechanism 734 moves the plate member 731 in the direction away from the application roller 732 so as to separate the plate member 731 from the application roller 732 as the toner discharge operation. Thus, the toner is discharged downward. Alternatively, as shown in FIG. 6C, the discharge mechanism 734 may rotate the plate member 731 around the application roller 732 while keeping the plate member 731 in contact with the application roller 732, thereby discharging toner over the free end of the tilting plate member 731. Alternatively, as shown in FIG. 6D, the discharge mechanism 734 may reduce an amount of protrusion of the plate member 731 from the holding member 731A while keeping the plate member 731 in contact with the application roller 732, thereby discharging toner over the free end of the plate member 731. Note that the toner discharge operation performed by the discharge mechanism 734 is not limited to the above-described examples. For example, the discharge mechanism 734 may move the plate member 731 downward while keeping the plate member 731 in contact with the application roller 732, thereby discharging toner over the free end of the plate member 731.

When the controller 10 determines that it is necessary to discharge the stored toner, the discharge mechanism 734 performs the toner discharge operation. When at least a portion of the stored toner is discharged by the toner discharge operation, non-deteriorated new toner can be stored in the storage space. As a result, non-deteriorated toner is supplied to the blade 733, and thus, a cleaning failure due to cut-surface wear of the blade 733 is prevented.

During the toner discharge operation, the application roller 732 is preferably driven and rotated by the drive motor 732A. The application roller 732 accelerates the removal of the toner adhering to the application roller 732 by a centrifugal force due to rotation. The application miler 732 preferably rotates at a speed with a linear speed ratio of from 0.3 to 1.7 relative to the intermediate transfer belt 72 in the width direction with respect to the conveyance direction of the intermediate transfer belt 72 so as not to damage the intermediate transfer belt, while accelerating the removal of adhering toner. Further, during the toner discharge operation, the application roller 732 is preferably rotated faster than during the normal operation. In one example, the application roller 732 rotates at speed with a linear speed ratio of 0.45 relative to the intermediate transfer belt 72 during the normal operation, and rotates at a speed with a linear speed ratio of 1.0 relative to the intermediate transfer belt 72 during the toner discharge operation.

Further, during the toner discharge operation, the image former 70 may form a band image (patch) extending in the conveyance direction of the intermediate transfer belt 72 on the intermediate transfer belt 72, and the toner included in the band image may be supplied to the blade 733 as the intermediate transfer belt 72 is conveyed. During the toner discharge operation, the image former 70 forms a hand image on the intermediate transfer belt 72, instead of the application roller 732 that cannot apply toner to the intermediate transfer belt 72. Thus, toner reaches the blade 733, whereby cut-surface wear of the blade 733 can be prevented. The amount of toner contained in the band image is preferably 0.5 g/m² or more and 6 g/m² or less. Further, the length of the band image (the length of the band image in the conveyance direction of the intermediate transfer belt 72) is preferably 30 mm or more and 4000 mm or less. Regarding the width of the band image (the width of the band image in the width direction perpendicular to the conveyance direction of the intermediate transfer belt 72), the band image may have a maximum possible width. The image former 70 may adjust the amount of toner included in the band image by adjusting the density of the band image while keeping the length of the band image constant, or by adjusting the length of the band image while keeping the density of the band image constant.

(Toner Discharge Process)

Next, the flow of the process of the image forming apparatus 1 will be described.

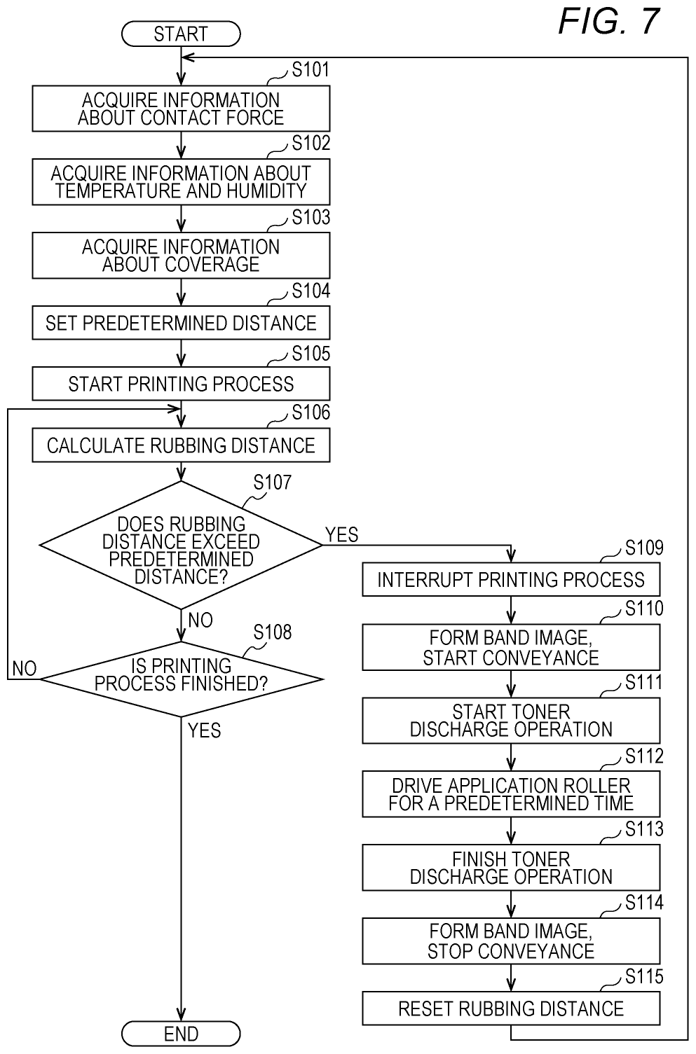

FIG. 7 is a flowchart illustrating a procedure of the process of the image forming apparatus. The processing algorithm shown in FIG. 7 is stored as a program in the storage 20, and is executed by the controller 10.

As shown in FIG. 7, first, the controller 10 acquires information about the contact force of the plate member 731 against the application roller 732 in a state where the printing process is not being executed (step S101). For example, the controller 10 acquires a numerical value indicating the contact force of the plate member 731 as information about the contact force of the plate member 731.

The controller 10 may calculate a shaft torque of the drive motor 732A that drives the application roller 732 as a numerical value indicating the contact force. For example, the controller 10 may calculate the shall torque of the drive motor 732A on the basis of T-I (torque-current) characteristics of the drive motor 732A measured in advance and stored in the storage 20, and the current flowing through the drive motor 732A. The current flowing through the drive motor 732A may be detected by an ammeter connected to the drive motor 732A. Alternatively, the controller 10 may calculate the shaft torque of the drive motor 732A on the basis of the detection result of a torque sensor connected to the drive motor 732A. Note that a method for calculating a numerical value indicating the contact force of the plate member 731 is not limited to those described above, and the controller 10 may directly calculate the contact force. For example, the controller 10 may calculate the contact force of the plate member 731 on the basis of the calculated shaft torque and information regarding, for example, a gear ratio for transmitting a drive and the outer diameter of the application roller 732 stored in the storage 20. Alternatively, the controller may calculate the contact force of the plate member 731 on the basis of an optically measured displacement amount of the plate member 731.

Subsequently, the controller 10 acquires information about the temperature and humidity in the image forming apparatus 1 (step S102). For example, the controller 10 acquires information about the temperature and humidity measured by a thermometer and a hygrometer arranged at an arbitrary location in the image forming apparatus 1.

Subsequently, the controller 10 acquires information about the coverage of an image to be printed (step S103). For example, the controller 10 acquires information about the coverage of an image to be printed on the basis of image data included in a print job received from the user's PC.

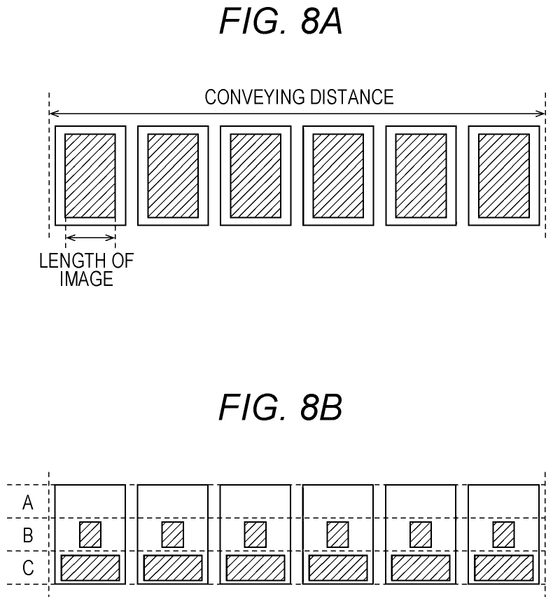

FIGS. 8A and 8B are diagrams for describing a method for calculating coverage of an image.

For example, as illustrated in FIG. 8A, the coverage of the image to be printed is calculated as a ratio of the length of the image to be printed on the predetermined number of sheets to the distance of the intermediate transfer belt 72 conveyed for the predetermined number of sheets. The distance the intermediate transfer belt 72 is conveyed is calculated in consideration of the total length of the predetermined number of sheets and an interval between the sheets in the conveyance direction of the intermediate transfer belt 72. Information about the length of an image to be printed is acquired on the basis of image data included in the print job. Note that the predetermined number of sheets may be the number of sheets that can be conveyed while the toner discharge operation is not performed (that is, during the normal operation) in a case where the timing of the toner discharge operation can be predicted to some extent, or may be an arbitrarily set number.

In addition, in consideration of a case where, for example, images unevenly positioned in the width direction perpendicular to the conveyance direction of the intermediate transfer belt 72 are continuously printed, a region where images can be printed may be divided into a plurality of regions in the width direction as illustrated in FIG. 8B, for example. Then, the coverage of the image in each region may be calculated, and the lowest coverage may be acquired as the coverage of the image to be printed. For example, in the example illustrated in FIG. 8B, the coverage of the image in each of three regions A to C is calculated, and the coverage in the region A having the lowest coverage is acquired as the coverage of the image to be printed.

Subsequently, the controller 10 sets a predetermined distance as a threshold on the basis of the information, acquired in steps S101 to S103, about the contact force of the plate member 731, the temperature and humidity in the image forming apparatus 1, and the coverage of the image to be printed (step S104). The predetermined distance is a threshold that is set with respect to a distance (hereinafter referred to as “rubbing distance”) the application roller 732 rotates while rubbing the plate member 731, and it is used in step S107 described later.

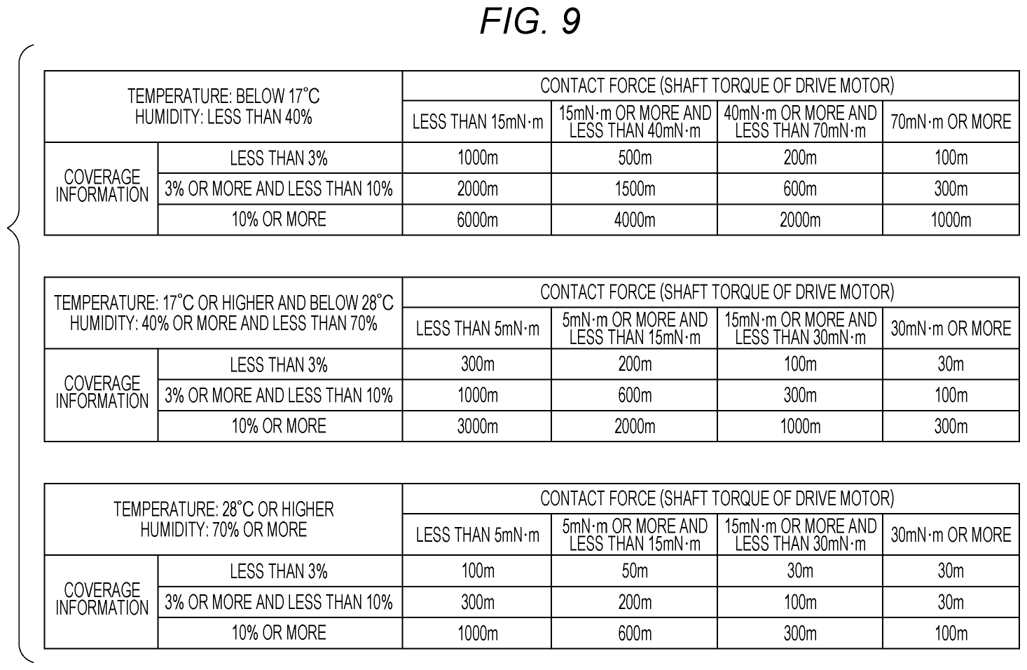

FIG. 9 is a diagram illustrating an example of a table for setting the predetermined distance.

The controller 10 sets the predetermined distance on the basis of the information acquired in steps S101 to S103 and the table as illustrated to FIG. 9 stored in the storage 20. In the example illustrated in FIG. 9, the shaft torque of the drive motor 732A is used as a numerical value indicating the contact force. As illustrated in FIG. 9, the predetermined distance is set to a smaller value as the torque (contact force) is larger, the temperature and humidity are higher, and the coverage is lower. However, the method for setting the predetermined distance is not limited to the abovementioned method. For example, the controller 10 may set a predetermined distance calculated on the basis of an arbitrary mathematical expression or the like.

Returning back to FIG. 7, the controller 10 starts (restarts) the minting process, and causes the image former 70, the fixing unit 80, and the like to start a predetermined printing operation (step S105). Then, the controller 10 starts measuring the driving time (rotation time) of the application roller 732 that has started to rotate, and calculates a rubbing distance on the basis of a cumulative value of the driving time of the application roller 732, and information about the rotating speed and the outer diameter (step S106). For example, the controller 10 calculates the rubbing distance by multiplying the rotation number calculated based on the cumulative value of the driving time of the application roller 732 and the rotating speed by the outer circumference calculated based on the outer diameter of the application roller 732. Note that the controller 10 may acquire information about the rotating speed of the application roller 732 detected by the drive motor 732A or stored in the storage 20. Further, the controller 10 may acquire information about the outer diameter of the application roller 732 stored in the storage 20.

Subsequently, the controller 10 determines whether or not the rubbing distance calculated in step S106 exceeds the predetermined distance calculated in step S104 (step S107). The controller 10 determines whether or not the rubbing distance exceeds the predetermined distance as a determination as to whether or not it is necessary to discharge the toner stored in the storage space. As the rubbing distance is longer, the time during which the stored toner has been rubbed by the application roller 732 is longer, and thus, the toner tends to deteriorate.

When determining that the rubbing distance does not exceed the predetermined distance (step S107: NO), the controller 10 determines whether or not the printing process is completed (step S108). When determining that the printing process is not completed (step S108: NO), the controller 10 repeats the processes in steps S106 to S108 until it determines that the rubbing distance exceeds the predetermined distance or that the printing process is completed.

When determining that the rubbing distance exceeds the predetermined distance (step S107: YES), the controller 10 interrupts the printing process (step S109). Then, the controller 10 causes the image former 70 to start forming a band image containing a predetermined amount of toner (or a band image having a predetermined length), and causes the intermediate transfer belt 72 to convey the band image (step S110). As a result, supply of toner contained in the band image to the blade 733 is started.

Subsequently, the controller 10 controls the discharge mechanism 734 so that the toner discharge operation is started (step S111). More specifically, the controller 10 controls the discharge mechanism 734 so that, for example, the plate member 731 is moved in a direction away from the application roller 732 so as to be separated from the application roller 732. Note that the timings of steps S110 and S111 may be adjusted so that the band image which is started to be formed in step S110 reaches the blade 733 upon the start of the process in step S111.

Further, the controller 10 controls the drive motor 732A so that the application roller 732 is driven and rotated for a predetermined time (step S112). The predetermined time may be a time necessary for removing the toner adhering to the application roller 732 by the centrifugal force generated by the rotation of the application roller 732. For example, the predetermined time may be a time necessary for the application roller 732 to rotate once. Further, the controller 10 may control the drive motor 732A so that the application roller 732 is rotated foster than during the normal operation. Note that the processes in steps S111 and S112 may be executed simultaneously.

Subsequently, the controller 10 causes the discharge mechanism 734 to finish the toner discharge operation (step S113). More specifically, the controller 10 controls the discharge mechanism 734 so that, for example, the plate member 731 is moved in a direction approaching the application roller 732 and brought into contact with the application roller 732. Then, the controller 10 determines whether or not the formation of the band image including the predetermined amount of toner started in step S110 is completed and the supply of the toner included in the band image to the blade 733 is completed (step S114).

When determining that the supply of toner included in the band image is completed (step S114: NO), the controller 10 waits until the supply of toner included in the band image is completed. That is, even after the toner discharge operation is finished and the storage space is formed again, a band image is formed until the use of a predetermined amount of toner is completed. The toner contained in the band image is not only supplied to the blade 733 but also supplied to the storage space and stored therein after the storage space is formed again.

When determining that the supply of the toner included in the band image is completed (step S114: YES), the controller 10 resets the rubbing distance calculated in step S106 (step S115). Then, the controller 10 returns to the process in step S101 and repeats the processes in steps S101 to S115 until determining in step S108 that the printing process is finished. Thereafter, when determining that the printing process is finished (step S108: YES), the controller 10 ends the process routine illustrated in FIG. 7.

The present embodiment has the following effects.

The cleaning device 73 includes the blade 733 that contacts the intermediate transfer belt 72, the application roller 732 that contacts the intermediate transfer belt 72 on the upstream side of the blade 733 in the conveyance direction of the intermediate transfer belt 72, the plate member 731 that contacts the application roller 732, and the discharge mechanism 734. The discharge mechanism 734 performs a toner discharge operation for discharging toner stored in a space formed above the contact part between the plate member 731 and the application roller 732. Accordingly, the cleaning device 73 can appropriately discharge the toner which has been continuously ribbed by the application roller 732 for a long period offline and thus has deteriorated with the external additive being embedded. Thus, the cleaning device 73 can prevent a cleaning failure due to cut-surface wear of the blade 733 which is caused depending on the state of the supplied toner.

Further, the discharge mechanism 734 performs, as the toner discharge operation, an operation of moving the plate member 731 away from the application roller 732. As a result, the stored toner is all discharged at a time and new toner can be stored, whereby the toner can be replaced efficiently.

Further, the application roller 732 rotates during the toner discharge operation. The application roller 732 can accelerate the removal of the toner adhering to the application roller 732 by a centrifugal force due to rotation.

Further, during the toner discharge operation, the application roller 732 rotates faster than during the normal operation. Thus, the application roller 732 can accelerate the discharge of, for example, toner having reduced fluidity, or toner adhering firmly to the application roller 732.

Further, during the toner discharge operation, the toner contained in the band image formed on the intermediate transfer belt 72 is supplied to the blade 733. As a result, toner is also reliably supplied to the blade 733 during the toner discharge operation, whereby cut-surface wear of the blade 733 can be prevented.

The amount of toner contained in the band image is from 0.5 g/m² to 6 g/m² inclusive. By appropriately setting the amount of toner contained in the band image, it is possible to prevent an occurrence of a cleaning failure due to cut-surface wear and a cleaning failure due to toner exceeding the cleaning limit of the blade 733.

The length of the band image is from 30 mm to 4000 mm inclusive. By appropriately setting the length of the band image, it is possible to prevent an occurrence of a cleaning failure due to cut-surface wear and a cleaning failure due to toner exceeding the cleaning limit of the blade 733.

Further, the image forming apparatus 1 includes the cleaning device 73, the intermediate transfer belt 72, and the controller 10 described above. The controller 10 determines whether or not it is necessary to discharge the toner stored in the storage space, and when determining that it is necessary to discharge the toner, the controller 10 causes the discharge mechanism 734 to perform the toner discharge operation. Thus, the discharge mechanism 734 can perform the toner discharge operation under the control of the controller 10.

Further, the controller 10 determines whether or not it is necessary to discharge the toner by checking whether the rubbing distance, which is the distance the application roller 732 rotates while rubbing the plate member 731, exceeds a predetermined distance. When determining that the rubbing distance exceeds the predetermined distance, the controller 10 causes the discharge mechanism 734 to perform the toner discharge operation. Thus, the controller 10 can easily and efficiently determine whether or not it is necessary to discharge the toner on the basis of the rubbing distance without requiring a special configuration, and the toner can be efficiently discharged.

Further, the controller 10 sets the predetermined distance on the basis of information about the contact force of the plate member 731 against the application roller 732. For example, the controller 10 can set the predetermined distance smaller, as the contact force increases, in consideration of a situation in which, with air increase in the contact force, the external additive is likely to be embedded, in the stored toner and the toner is likely to deteriorate.

Further, the controller 10 acquires, as the information about the contact force of the plate member 731, the shaft torque of the drive motor 732A calculated on the basis of the current flowing through the drive motor 732A that drives the application roller 732. Thus, the controller 10 can easily obtain a numerical value indicating the contact force without including a sensor or the like that directly detects the contact force.

Further, the controller 10 sets the predetermined distance on the basis of the temperature and humidity in the apparatus and information about the coverage of an image to be printed. For example, the controller 10 can set the predetermined distance smaller, as the temperature and humidity are higher, in consideration of a situation in which, with an increase in the temperature and humidity, the fluidity of toner is likely to reduce due to aggregation of toner, and the stored toner is less likely to be replaced, which leads to deterioration of toner. The controller 10 can also set the predetermined distance smaller, as the coverage of the image to be printed is lower, in consideration of a situation in which, with a decrease in the coverage, the stored toner is less likely to be replaced, which leads to deterioration of toner.

Further, the controller 10 calculates the rubbing distance on the basis of the cumulative value of the driving time of the application roller 732 and information about the rotating speed and the outer diameter. Thus, the controller 10 can calculate the rubbing distance easily and efficiently.

The present invention is not limited only to the embodiment mentioned above, and various modifications and improvements are possible without departing from the scope of claims.

For example, the above embodiment describes, as one example, the case of preventing a cleaning failure due to cut-surface wear of the blade 733 in the cleaning device 73 that cleans the intermediate transfer belt 72. However, the cleaning device to which the present invention is applied is not limited to the cleaning device 73 that cleans the intermediate transfer belt 72, and may be a cleaning device 716 that cleans the photosensitive drum 711. That is, the present invention may be applied to prevent an occurrence of a cleaning failure due to cut-surface wear of a cleaning blade in the clearing device 716 that cleans the photosensitive drum 711.

The above embodiment describes, as one example, the case where the controller 10 determines whether or not it is necessary to discharge the toner stored in the storage space by checking whether or not time rubbing distance exceeds the predetermined distance. However, the present embodiment is not limited thereto.

For example, if the cleaning device 73 is not used for a long time (for example, the printing process is not executed for a long time), the toner stored in the storage space aggregates and the fluidity of the toner reduces. When the toner fluidity reduces, the performance for applying toner to the application roller 732 by the plate member 731 also deteriorates, so that toner in an amount necessary for preventing cut-surface wear of the blade 733 is not supplied to the blade 733. For this reason, the controller 10 may determine whether or not it is necessary to discharge the toner on the basis of the elapsed time in which the apparatus is not operated. More specifically, the controller 10 may determine whether or not it is necessary to discharge the toner by checking whether or not the elapsed time in which the apparatus is not operated (the time in which the apparatus is not in use) is equal to or longer than a predetermined time. When determining that the elapsed time is equal to or longer than the predetermined time, the controller 10 may cause the discharge mechanism 734 to perform the toner discharge operation. The predetermined time may be, for example, 24 hours. This can prevent an occurrence of a cleaning failure caused by cut-surface wear of the blade 733 due to reduced fluidity of the supplied toner.

When the temperature in the apparatus (image forming apparatus 1) rises rapidly, the toner stored in the storage space is condensed and aggregated, and the fluidity a the toner reduces. When the fluidity of the toner reduces, toner in an amount necessary for preventing cut-surface wear of the blade 733 is not supplied to the blade 733 as described above. For this reason, the controller 10 may determine whether or not it is necessary to discharge the toner on the basis of an increase in temperature in the apparatus. More specifically, in order to determine whether or not it is necessary to discharge the toner, the controller 10 may determine whether or not an increase in the temperature in the apparatus upon the start of a new printing process from the temperature in the apparatus at the end of the previous printing process is equal to or higher than a predetermined temperature. When determining that the increase in the temperature in the apparatus is equal to or higher than the predetermined temperature, the controller 10 may cause the discharge mechanism 734 to perform the toner disc operation. The predetermined temperature may be, for example, 15° C. This can prevent an occurrence of a cleaning failure caused by cut-surface wear of the blade 733 due to reduced fluidity of the supplied toner. Note that the controller 10 may determine whether or not it is necessary to discharge the toner on the basis of a variation in the temperature including not only an increase but also a decrease in the temperature in the apparatus.

It is preferable that, during the toner discharge operation based on the elapsed time in which the apparatus is not operated or based on a variation in the temperature in the apparatus, the application roller 732 rotates faster than during the toner discharge operation based on the rubbing distance. In one example, the application roller 732 rotates at a speed with a linear speed ratio of 0.45 relative to the intermediate transfer belt 72 during the normal operation in the printing process, rotates at a speed with a linear speed ratio of 1.0 relative to the intermediate transfer belt 72 during the toner discharge operation based on the rubbing distance, and rotates at a speed with a linear speed ratio of 1.5 relative to the intermediate transfer belt 72 during the toner discharge operation based on the elapsed time or variation in temperature. The application roller 732 can accelerate the discharge of toner which is less likely to be discharged, such as toner having reduced fluidity or toner firmly adhering to the application roller 732, in a case where the elapsed time is equal to or longer than the predetermined time or a variation in the temperature in the apparatus is equal to or higher than the predetermined temperature.

The above embodiment describes, as one example, the case where the controller 10 determines whether or not it is necessary to discharge the toner stored in the storage space on the basis of the rubbing distance. However, the present embodiment is not limited thereto. The controller 10 may determine whether or not it is necessary to discharge the toner on the basis of the cumulative value of the driving time of the application roller 732, the rotation number, or the like instead of the rubbing distance. The controller 10 may also determine whether or not it is necessary to discharge the toner on the basis of a frictional force between the intermediate transfer belt 72 and the blade 733 or a load received by the intermediate transfer belt 72 from the blade 733, the frictional force and the load being changed according to the state of toner supplied to the blade 733. For example, in consideration of a situation in which, when the deteriorated toner is supplied to the blade 733, a torque of a load (blade load torque) received by the intermediate transfer belt 72 from the blade 733 increases, the controller 10 may perform determination based on the blade load torque. The blade load torque may be detected by a torque sensor. Alternatively, in consideration of a situation in which, when the deteriorated toner is supplied to the blade 733, a distortion amount (deflection amount) of the blade 733 detected by a strain gauge increases, the controller 10 may perform determination based on the distortion amount of the blade 733.

The above embodiment describes, as one example, the case where the controller 10 acquires information about the coverage of an image to be printed. However, the present embodiment is not limited thereto. The controller 10 may cause the storage 20 to store information about the coverage of an image printed at a predetermined time in the past or printed on the predetermined number of sheets. Then, the controller 10 may acquire the information about the coverage of images printed in the past, and predict the state of toner already stored in the storage space on the basis of the acquired information.

The above embodiment describes, as one example, the case where the controller 10 acquires information about the outer diameter of the application roller 732 stored in the storage 20. However, the present embodiment is not limited thereto. The outer diameter of the application roller 732 is gradually reduced by the contact force of the plate member 731 against the application roller 732. For this reason, the storage 20 may store information indicating the relationship between the rubbing distance and a change in the outer diameter of the application roller 732. Then, the controller 10 may acquire the information about the current outer diameter of the application roller 732 on the basis of the information.

The processes according to the above embodiment may include steps other than the steps mentioned above, or may not include some of the steps mentioned above. Further, the order of the steps is not limited to the order described in the above embodiment. Furthermore, each step may be combined with other steps and executed as a single step, may be included in another step, or may be divided into a plurality of steps.

The means and method for performing various types of processes in the image forming apparatus 1 according to the above embodiment can be achieved by either a dedicated hardware circuit or a programmed computer. The abovementioned program may be provided by a computer-readable recording medium such as a compact disc read only memory (CD-ROM), or may be provided online via a network such as the Internet. In this case, the program recorded on the computer-readable recording medium is usually transferred to and stored in a storage such as a hard disk. Further, the abovementioned program may be provided as a single piece of application software, or may be incorporated into the software as one function of the image forming apparatus 1.

### EXAMPLE

The embodiment of the present invention will now be described in more detail by way of examples. However, the present invention is not limited by the examples.

In a cleaning device having the same configuration as that of the abovementioned embodiment, a toner discharge operation based on the rubbing distance was performed, and cut-surface wear of a blade was evaluated.

A member made of SUS304-CSP with a thickness of 70 μm was used as the plate member. The distance from the center of the contact part between the plate member and the application roller (center of the nip) to the upper end (free end) of the plate member was set to 8 mm.

A member made of nitrite butadiene rubber (NBR) was used as the application roller. As an elastic layer of the application roller, a foamed sponge having a thickness of 2 μm and a hardness (Aster C hardness) of 30° was used. The application roller was rotated in the width direction with respect to the conveyance direction of an intermediate transfer belt at a speed with a linear speed ratio of 0.45 relative to the intermediate transfer belt. Further, the amount of engagement of the application roller with the intermediate transfer belt was set to 1.0 mm.

A member made of urethane rubber was used as the blade, the contact pressure against the intermediate transfer belt was set to 32 N/m, and the contact angle was set to 16.6°.

Table 1 shows the result of evaluating cut-surface wear of the blade when the toner discharge operation was performed and when the toner discharge operation was not performed. In Table 1, “◯” indicates that cut-surface wear of the blade did not occur, “Δ” indicates that cut-surface wear of the blade occurred, and “x” indicates that the edge of the blade became worn due to cut-surface wear of the blade, and a cleaning failure occurred.

TABLE 1

| | TONER DISCHARGE | |
|---|---|---|
| NUMBER OF | OPERATION IS NOT | TONER DISCHARGE |
| SHEETS [kp] | PERFORMED | OPERATION IS PERFORMED |
| 50 | ∘ | ∘ |
| 100 | ∘ | ∘ |
| 200 | Δ | ∘ |
| 300 | x | ∘ |
| 100 | x | ∘ |
| 500 | x | ∘ |

Table 1 shows that, when the toner discharge operation based on the rubbing distance is performed, cut-surface wear of the blade can be prevented for a long period of time, and thus, a cleaning failure can be prevented.

Although embodiments of the present invention have been described and illustrated in detail, the disclosed embodiments are made for purposes of illustration and example only and not limitation. The scope of the present invention should be interpreted by terms of the appended claims.

What is claimed is:

1. A cleaning device comprising:
a cleaning blade that contacts an image carrier and cleans the image carrier;
an application roller that contacts the image carrier on an upstream side of the cleaning blade in a conveyance direction of the image carrier and applies toner to the image carrier;
a plate member that contacts the application roller and applies the toner to the application roller; and
a discharge mechanism that performs a toner discharge operation for discharging the toner stored in a space formed above a contact part between the plate member and the application roller.

2. The cleaning device according to claim 1, wherein the discharge mechanism performs an operation of moving the plate member away from the application roller as the toner discharge operation.

3. The cleaning device according to claim 1, wherein the application roller rotates during the toner discharge operation.

4. The cleaning device according to claim 3, wherein, during the toner discharge operation, the application roller rotates faster than during a normal operation in a printing process.

5. The cleaning device according to claim 1, wherein the toner included in a band image formed on the image carrier and extending in the conveyance direction is supplied to the cleaning blade during the toner discharge operation.

6. The cleaning device according to claim 5, wherein art amount of the toner contained in the band image is from 0.5 g/m² to 6 g/m² inclusive.

7. The cleaning device according to claim 5, wherein a length of the band image in the conveyance direction is from 30 mm to 4000 mm inclusive.

8. An image forming apparatus comprising:
the cleaning device according to claim 1;
the image carrier; and
a hardware processor that determines whether it is necessary to discharge the toner, and when determining that it is necessary to discharge the toner, causes the discharge mechanism to perform the toner discharge operation.

9. The image forming apparatus according to claim 8, wherein the hardware processor determines whether it is necessary to discharge the toner by determining whether a rubbing distance exceeds a predetermined distance, the rubbing distance being a distance the application roller rotates while rubbing the plate member, and when determining that the rubbing distance exceeds the predetermined distance, the hardware processor causes the discharge mechanism to perform the toner discharge operation.

10. The image forming apparatus according to claim 9, wherein the hardware processor sets the predetermined distance based on information about a contact force of the plate member against the application roller.

11. The image forming apparatus according to claim 10, wherein the hardware processor acquires, as the information about the contact force, a shaft torque of the drive motor calculated based on a current flowing through a drive motor that drives the application roller.

12. The image forming apparatus according to claim 9, wherein the hardware processor sets the predetermined distance based on a temperature and humidity in the apparatus and information about a coverage of an image to be printed.

13. The image forming apparatus according to claim 9, wherein the hardware processor calculates the rubbing distance based on a cumulative value of a driving time of the application roller, and information about a rotating speed and an outer diameter.

14. The image forming apparatus according to claim 8, wherein the hardware processor determines whether it is necessary to discharge the toner based on an elapsed time in which the apparatus is not operated.

15. The image forming apparatus according to claim 8, wherein the hardware processor determines whether it is necessary to discharge the toner based on a variation in the temperature in the apparatus.
